(19) United States
(12) Patent Application Publication
(10) Pub. No.: US 2026/0319830 A1
(43) Pub. Date: Oct. 15, 2026

(54) MEMORY PROCESSING ACCELERATORS AND SYSTEMS

(71) Applicant: Google LLC, Mountain View, CA (US)

(72) Inventors: Keun Young Park, Santa Clara, CA (US); Stephen Michael Blackburn, Canberra (AU); Mark Woh, San Bruno, CA (US); Chakravarthy Srinivas Kosaraju, Saratoga, CA (US); Thierry Gloude Rajappa, Mountain View, CA (US); Wei-Han Chen, Taipei (TW); Martin Christoph Maas, Mountain View, CA (US)

(21) Appl. No.: 19/465,683

(22) Filed: Jan. 30, 2026

Related U.S. Application Data
(60) Provisional application No. 63/752,019, filed on Jan. 31, 2025.

(51) Int. Cl. G06F 9/48; G06F 9/30

(52) U.S. Cl. CPC G06F 9/4856; G06F 9/30047; G06F 9/3009

(57) ABSTRACT

Systems and methods including a memory offloading engine, and one or more memory acceleration processing elements (PEs), where each memory acceleration PE is configured to: receive a respective memory operation task, wherein the respective memory operation task is associated with corresponding target data, and communicate with a data cache when the corresponding target data is in the data cache or schedule a memory-to-memory operation with an external memory for the memory offloading engine when the corresponding target data is not in the data cache.

### CLAIM OF PRIORITY

This application claims priority under 35 USC §119(e) to U.S. Patent Application Serial No. 63/752,019, filed on Jan. 31, 2025, the entire contents of which are herein incorporated by reference.

### BACKGROUND

This specification generally relates to memory acceleration processing devices, systems, and methods.

In modern computing systems, the demand for high-performance data processing continues to grow due to the increasing complexity of applications such as artificial intelligence (AI) and machine learning (ML). These applications often require rapid access to a memory and manipulation of large datasets stored in the memory. Traditional memory management methods and systems may rely heavily on central processing units (CPUs) for data processing, and thus may face challenges such as latency, power inefficiency, and additional overhead in data access scheduling.

### SUMMARY

This specification describes a memory acceleration system for more efficient performance of memory operations, such as, for example, garbage collection. The memory acceleration system can include multiple memory acceleration processing elements (PEs) configured to receive memory-intensive operation tasks, offloaded from a main processor, and manage data access using a shared data cache and a dedicated memory offloading engine.

Particular embodiments of the subject matter described in this specification can be implemented so as to realize one or more of the following advantages.

While direct memory access (DMA) controllers and general purpose CPUs provide basic capabilities for accessing memory, they lack specialized functionalities required for complex memory operations with irregular memory access patterns. An example task involving such memory operations is garbage collection, which can often be dominated by pointer chasing operations. As a result, memory acceleration methods and systems, which can offload tasks from the CPU and enable hardware-accelerated operations to reduce memory access latency and enhance data transfer throughput, are desired.

In one aspect of the specification, an example memory acceleration system is provided. The memory acceleration system can include multiple processor elements (PEs) with capability to offload memory access to a separate memory access block. The memory acceleration system can have a common data cache, and the memory access block can load required data from an external memory into this data cache. With multiple threads of execution running in each PE, each thread can run until it is blocked for data load. Then, another ready thread of execution can be scheduled to allow each PE to maximize active CPU cycle times without being stalled for data load. In an example garbage collection task, with enough concurrent memory accesses, this design shows that the marking phase of garbage collection can be significantly improved.

In addition, to reduce the impact to a main CPU system, the accelerator may only require input/output (I/O) coherency and atomic operations support. To maintain the I/O coherency, a software stack associated with the memory acceleration system can identify memory addresses that require coherency synchronization. In scenarios involving dynamic memory management (e.g., garbage collection algorithms), the described techniques can provide mechanisms to explicitly call out dirty objects that require new synchronization after update from the host side.

The memory acceleration system also has the capability to directly navigate a host processor’s memory mapping, thereby enhancing efficiency of the memory management. In some instances, re-creating memory mapping table for every target user process’s heap memory during garbage collection may introduce substantial latency (e.g., several hundred milliseconds). To address this issue, the memory acceleration system can utilize dedicated memory management unit (MMU) and shared virtual address mechanism, for example, provided by the Linux kernel’s input/output memory management unit (IOMMU) driver stack. This approach can allow efficient access to host user’s memory space by only setting address space identifier (ASID) and MMU registers. It is understood that the example of the Linux kernel’s IOMMU driver stack is for illustration and is not intended to be construed in a limiting sense. In practice, any suitable alternative designs can be applied to the described techniques.

At a high level, the memory acceleration system can enhance the speed and efficiency of memory operations, such as garbage collection, by offloading memory-intensive tasks from the main CPU to specialized PEs. The Pes can intelligently manage data access using the common data cache and a dedicated MMU to minimize delays and boost data flow.

In some implementations, the memory acceleration system includes a memory offloading engine and a plurality of memory acceleration PEs. Each memory acceleration PE can be configured to receive a respective memory operation task. The respective memory operation task is associated with corresponding target data. When the corresponding target data is in a data cache, the memory acceleration PE can be configured to communicate with the data cache. Otherwise, when the corresponding target data is not in the data cache, the memory acceleration PE can be configured to schedule a memory-to-memory operation with an external memory for the memory offloading engine.

In some implementations, each memory acceleration PE is configured to execute threads, co-routines, or a combination of threads and co-routines.

In some implementations, the memory acceleration system further includes a remapper coupled to the data cache and configured to: receive a status request associated with the corresponding target data from each memory acceleration PE; and transmit a status response to each memory acceleration PE, where the status response indicates whether or not the corresponding target data is in the data cache.

In some implementations, the memory acceleration system further includes a job dispatcher configured to manage a plurality of memory operation tasks for the plurality of memory acceleration PEs. The plurality of memory acceleration PEs includes a first memory acceleration PE. The plurality of memory operation tasks includes a first memory operation task and a second memory operation task both assigned to the first memory acceleration PE, where the first memory operation task is associated with first target data.

In some implementations, the first memory acceleration PE is configured to perform: receiving the first memory operation task and the second memory operation task through the job dispatcher; executing a first thread to process the first memory operation task; pausing the first thread; and executing a second thread to process the second memory operation task.

In some implementations, executing the first thread to process the first memory operation task includes: determining whether the first target data is in the data cache; when the first target data is not in the data cache, generating an instruction to perform a first memory-to-memory operation based on the first memory operation task; and transmitting the instruction to perform the first memory-to-memory operation to the memory offloading engine.

In some implementations, the first memory acceleration PE is configured to: receive a message from the memory offloading engine, where the message indicates that the first memory-to-memory operation is finished; and resume the first thread to continue a remaining part of the first memory operation task.

In some implementations, the plurality of memory operation tasks further includes a third memory operation task that is associated with the first target data and is assigned to a second memory acceleration PE of the plurality of memory acceleration PEs.

In some implementations, the memory offloading engine is configured to: receive the instruction to perform the first memory-to-memory operation from the first memory acceleration PE; receive an instruction to perform a second memory-to-memory operation from the second memory acceleration PE, where the second memory-to-memory operation is associated with the first target data and is generated by the second memory acceleration PE based on the third memory operation task, and the first memory-to-memory operation and the second memory-to-memory operation are atomic memory operations; and perform the first memory-to-memory operation and the second memory-to-memory operation with the external memory asynchronously.

In some implementations, the memory acceleration system is coupled to a host processor and is configured to receive the plurality of memory operation tasks from the host processor.

In some implementations, the host processor and the memory acceleration system are configured to share the data cache, the data cache includes a static random-access memory (SRAM), and the external memory includes a dynamic random-access memory (DRAM).

Another aspect of this specification features a computer-implemented method performed using a memory acceleration system. The method includes: receiving a respective memory operation task, where the respective memory operation task is associated with corresponding target data; and communicating with a data cache when the corresponding target data is in the data cache or schedule a memory-to-memory operation with an external memory for a memory offloading engine of the memory acceleration system when the corresponding target data is not in the data cache.

Another aspect of this specification features a non-transitory machine-readable storage medium, storing instructions that are executable by a processing system to cause performance of operations. The operations include: receiving a respective memory operation task, where the respective memory operation task is associated with corresponding target data; and communicating with a data cache when the corresponding target data is in the data cache or schedule a memory-to-memory operation with an external memory for a memory offloading engine of the processing system when the corresponding target data is not in the data cache.

### BRIEF DESCRIPTION OF THE DRAWINGS

FIG. 1 is a block diagram of an example computing system.

FIG. 2 is a block diagram of an example memory acceleration system.

FIG. 3 is a message sequence chart illustrating an example process performed by the memory acceleration system.

Like reference numbers and designations in the various drawings indicate like elements.

### DETAILED DESCRIPTION

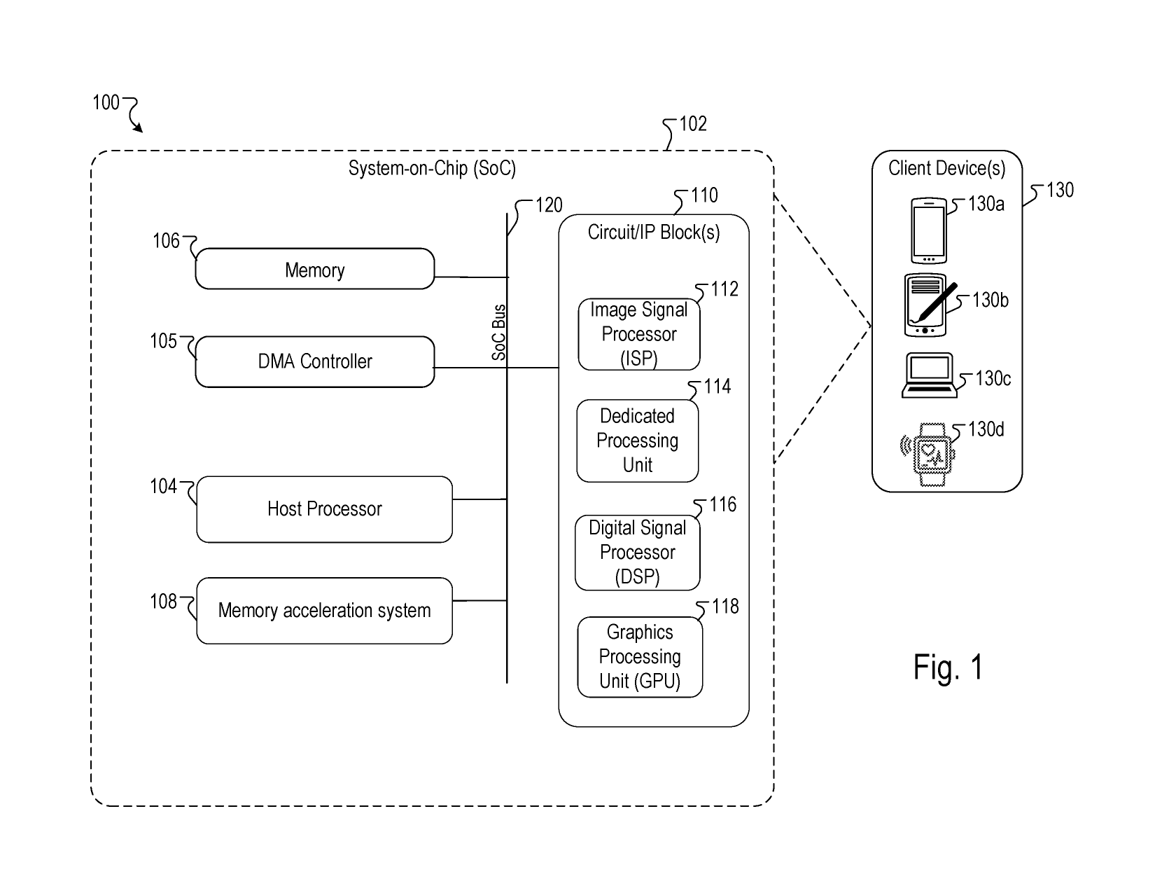

FIG. 1 is a block diagram of an example computing system 100 that includes a system-on-chip 102 (“SoC 102”). In some implementations, the computing system 100 (“system”) is implemented on a user/client device 130. The SoC 102 includes a host processor 104, a direct memory access (DMA) controller 105, a memory 106, a memory acceleration system 108, and an IP/circuit block 110. The host processor 104 can also be referred to as a central processing unit (“CPU 104”). In some implementations, system 100 can include multiple SoCs. It is understood that any descriptions for the SoC 102 herein are equally applicable to each of the multiple SoCs that may be included at system 100.

The memory 106 can be a system memory, shared memory, or both. In the example of FIG. 1, memory 106 is depicted external to the IP/circuit block 110. However, memory 106 can include portions of memory that are: i) specific to circuit block 110, ii) external to the IP/circuit block 110, or iii) both. The memory 106 can be random access memory of the SoC 102, such as static random access memory (SRAM), dynamic random access memory (DRAM), a synchronous DRAM (SDRAM), or double data rate (DDR) SDRAM.

In some implementations, aspects of memory 106 are configured as a shared scratchpad memory that supports parallel access of its memory resources by two or more processors of the IP/circuit 110. Memory 106 can also include various other types of memory, such as high bandwidth memory (HBM), narrow memory (e.g., for storing 8-bit values), wide memory (e.g., for storing 16-bit or 32-bit values), etc.

The DMA controller 105 can be configured to manage DMA operations. The DMA operations allow data to be transferred between memory and peripherals or between different memory regions without involving a processor (e.g., the host processor 104) for each individual data transfer. This can improve system performance and free up the processors to perform other tasks.

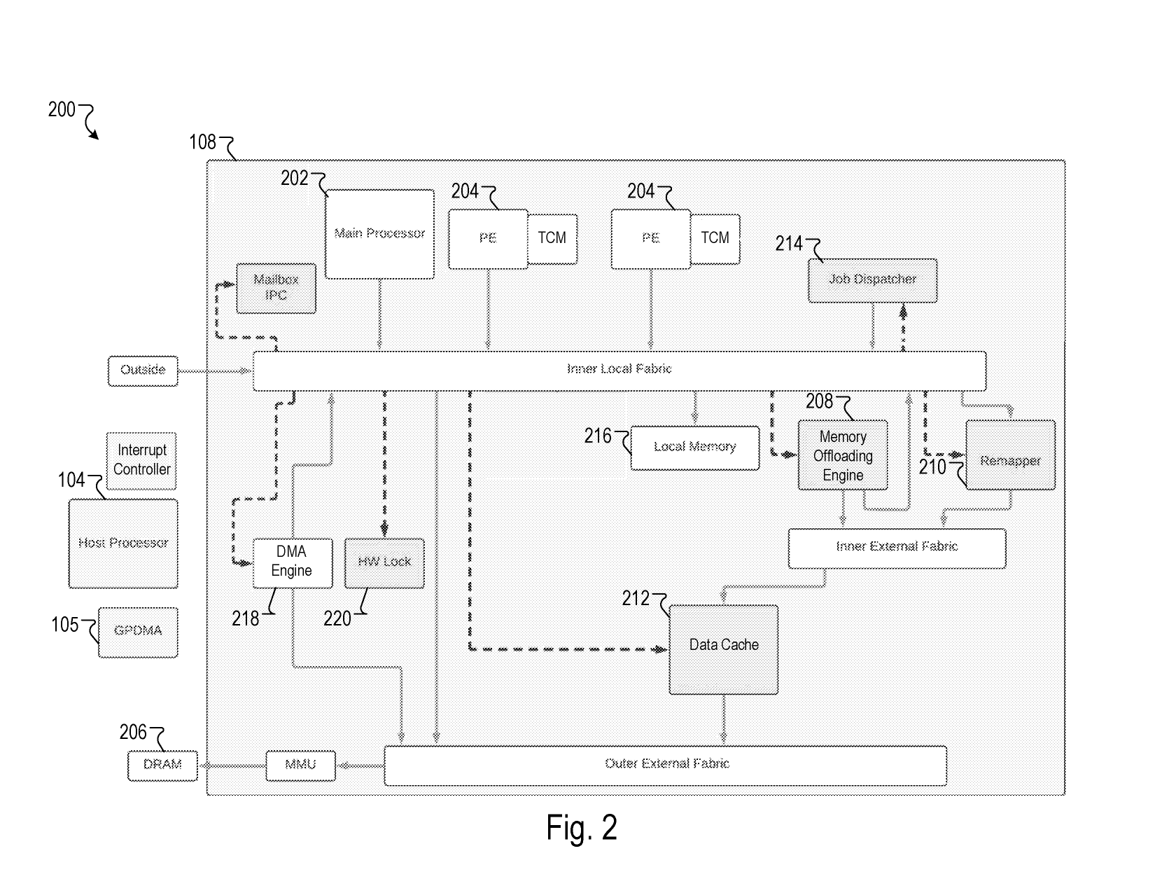

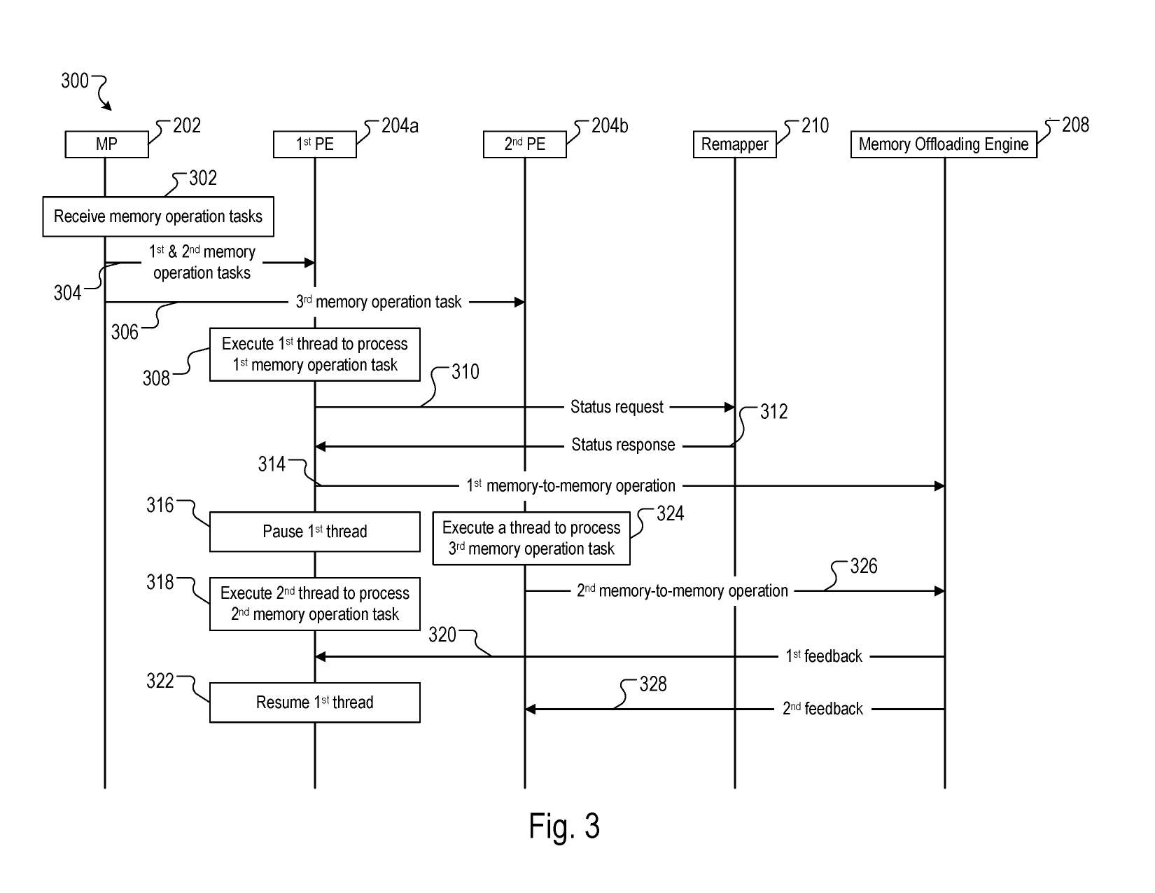

The memory acceleration system 108 is designed to enhance memory operation performance for the host processor 104. The memory acceleration system 108 can be configured to accelerate memory-related tasks, reduce latency, increase throughput, or offload work from the host processor 104. For example, the memory acceleration system 108 can include multiple cores (e.g., memory acceleration processing element (PE) 204 of FIG. 2), and each core has capability to offload memory access to a separate hardware unit (e.g., memory offloading engine 208 of FIG. 2). In some implementations, each core can be configured to run multiple threads. One thread can run until it is blocked for data load, then another ready thread can be scheduled for another data access task. In this way, each core can efficiently utilize processing cycle times without being stalled for data access. Details of the memory acceleration system 108 are described with reference to FIGS. 2 and 3 below.

The IP/circuit block 110 generally includes individual IP devices such as processors, processor cores, or special-purpose processing devices. For example, the IP/circuit block 110 can include an image signal processor (ISP) 112, a dedicated processing unit 114, a digital signal processor (DSP) 116, and a graphics processing unit (GPU) 118. The IP/circuit block 110 is referred to alternatively as an IP block 110, where the IP block can include one or more hardware elements. For example, each of the ISP 112, dedicated processing unit 114, DSP 116, and GPU 118 can be a respective IP block (or IP device) of a particular entity or device manufacturer.

The dedicated processing unit 114 can be designed specifically to rapidly perform complex calculations required for a dedicated task (e.g., a machine learning task). In some implementations, the dedicated processing unit 114 is a special-purpose processor, such as machine learning hardware accelerator, neural processor unit, neural network processor, or an application-specific processor. In some implementations, the dedicated processing unit 114 is a neural network tensor processor that includes an integrated circuit architecture configured for power-efficient execution of machine learning computations using tensor constructs such as multi-dimensional matrices.

The host processor 104 or the CPU 104 can be a general purpose CPU. The host processor 104 can be configured as an instruction and vector data processing engine that processes data obtained from a system memory of the SoC 102, such as memory 106. In some implementations, each processor (e.g., ISP 112, DSP 116, dedicated processing unit 114, GPU 118) of the SoC 102 includes multiple cores. The host processor 104 can generate control signaling to minimize the processing load at each core of the processors. The control signaling is routed at system 100, for example, using a bus 120 of the SoC 102. The control signaling can include commands, requests, data, instructions, or a combination of these.

In the example of FIG. 1, the SoC 102 is an integrated circuit of an example user/client device 130, consumer electronic device, or mobile device. Each of these devices can include items such as a smartphone 130a, tablet 130b, laptop 130c, smartwatch or wearable device 130d. The devices 130 may also include, e.g., an eNotebook, Netbook, smart speaker, or mobile computer. In some implementations, the system 100 and the SoC 102 are integrated circuits of a desktop computer, network server, or related cloud-based asset.

FIG. 2 is a block diagram of an example computing system 200. The computing system 200 can be an implementation of the system 100 of FIG. 1. As shown in FIG. 2, the computing system 200 includes the host processor 104, the DMA controller 105, the memory acceleration system 108, and a DRAM 206. The DRAM 206 can be an example of the memory 106 of FIG. 1. In some implementations, the memory 106 (e.g., the external memory ) can be any suitable memories, such as a solid-state drive (SSD), a random-access memory (RAM), or a static random-access memory (SRAM).

The memory acceleration system 108 can include a main processor 202, a plurality of memory acceleration processing elements (PEs) 204 (“PEs 204”), a memory offloading engine 208, a remapper 210, a data cache 212, and a job dispatcher 214. The main processor 202 is responsible for managing memory requests from the host processor 104 and delegating memory operation tasks to the PEs 204. By farming out these memory requests to the PEs 204, the main processor 202 can ensure that the host processor 104 and the memory acceleration system 108 do not need to wait for the memory operation tasks to complete. This approach allows the memory acceleration system 108 to maintain high throughput by continuously processing new instructions while memory operations are being handled (e.g., asynchronously) by the PEs 204. In some implementations, the main processor 202 can be responsible for at least one of host communication, setting up and/or initialization, task queue maintenance, or management of the PEs 204. In some implementations, the main processor 202 is a 32-bit or 64-bit processing unit, which can allow for simpler interaction with host and require less patching. It is understood that this example is for illustration purpose and should not be construed in a limiting sense. In practice, any processing unit with suitable processing capability can be used as the main processor 202. In practice, the memory acceleration system 108 can include a large number of PEs 204 (e.g., hundreds or even thousands). The number of PEs 204 included in the memory acceleration system 108 can depend on various factors including, but not limited to, an application type or a scenario of the memory operations that are to be accelerated, memory latency, capability of each PE 204, and power consumption requirements. For example, in garbage collection, the number of PEs 204 can depend on a number of objects in the object graph.

The PEs 204 can be a processing unit responsible for executing memory related tasks. The PEs 204 can be programmable and can perform generic processing. In some implementations, each PE 204 can be a core of CPU, GPU, or DSP. The PEs 204 can be specialized or customized processors, which are designed to efficiently perform specific tasks or operations, rather than a broad range of tasks like general purpose CPUs. For example, the PEs 204 can be configured to process a reduced instruction set that focuses on simple operations such as transferring data between registers or memories. In some implementations, the PEs 204 can be processing units with acceleration hardware (e.g., ARM processors with acceleration extensions) or the PEs 204 themselves can be acceleration hardware. Alternatively, in some other implementations, each PE 204 can be a fixed function hardware rather than a generic processor. As shown in FIG. 2, each PE 204 can include at least one tightly coupled memory (TCM). In some implementations, the at least TCM for each PE 204 can include an instruction tightly coupled memory (ITCM) and a data tightly coupled memory (DTCM), which can be designed to provide low-latency and high-speed access to instructions and data (e.g., for internal context management and/or code). In some implementations, each PE 204 can be a 32-bit reduced instruction set computer (RISC)-V core.

The memory offloading engine 208 can be responsible for coordinating memory operations for the main processor 202 and the PEs 204. The memory operations can be memory-to-memory operations performed with an external memory (e.g., the DRAM 206). In some implementations, the memory operations can be between a memory and a data cache, between a memory (e.g., an external memory or a global memory) and a local memory, or between a memory and a TCM, etc. In some implementations, the memory operations can be performed in a host virtual address (VA) space, which refers to a range of virtual memory addresses available to a process or application in the computing system’s host virtual memory. The host virtual memory addresses can be mapped to physical addresses of an external memory (e.g., the DRAM 206). In some implementations, the memory offloading engine 208 can support atomic memory operations for the main processor 202 and the PEs 204. In some implementations, the memory offloading engine 208 is a major component and is the point of coherency and serialization for the PEs 204. The memory offloading engine 208 can resolve hazards between the PEs 204. The memory offloading engine 208 can be responsible for performing external memory operations to external host VA process space with internal programming memory commands (e.g., the main processor 202 and the PEs 204). In some implementations, the memory offloading engine 208 only maintains coherency and consistency for local hardware.

The remapper 210 can be a quick path for the main processor 202 and the PEs 204 to access the host VA space. The remapper 210 can be used as a path (e.g., a cheaper path) for the line hit check and load. In some implementations, the remapper 210 can also directly access the host VA space with configurable attributes.

The data cache 212 can be a cache (e.g., a specialized cache) that provides normal line based caching mechanisms for the PEs 204 and the main processor 202. The data cache 212 can also support extra features such as line locking, line hit check and load, or page coloring. In some implementations, the data cache 212 can be memory module that includes at least a SRAM. For example, the data cache 212 can further include one or more internal memories (not shown in FIG. 2). In some implementations, the data cache 212 can be shared by the host processor 104 and the memory acceleration system 108. For example, the data cache 212 can be outside of the memory acceleration system 108.

The job dispatcher 214 can manage a task queue for the PEs 204. For example, the job dispatcher 214 can be responsible for managing tasks in the task queue and assigning the tasks to the PEs 204. In some implementations, the task management can include adding a new task to the task queue, reordering existing tasks in the task queue (e.g., based on priorities or resources associated with the tasks), or removing a task from the task queue. The job dispatcher 214 can be configured to ensure that the PEs 204 are utilized efficiently. In some implementations, the main processor 202 can manage the task queue and pull task from the task queue while the PEs 204 get interrupts. The job dispatcher 214 can be optional. In some implementations, the memory acceleration system 108 may not include a job dispatcher and may obtain tasks from the main processor 202 or from the host processor 104 directly.

The memory acceleration system 108 can include one or more local memories 216 configured to perform tasks such as code fragments, shared memory between the main processor 202 and the PEs 204, and memory heap for a thread.

The memory acceleration system 108 can further include a DMA engine 218 configured to allow for external and/or internal memory to memory copying (e.g., between the host VA or between the host VA and the local memory 216).

As shown in FIG. 2, the memory acceleration system 108 can further include a hardware lock 220. In some implementations, the hardware lock 220 can be a special mutex that allows for internal and external clients to request a lock. For example, clients can be differentiated such that an original client to request the lock will always read an “Acquired” message. Other clients would read “Busy” until the original client which acquired the lock releases it. In some implementations, the host processor 104, the main processor 202, and the PEs 204 can participate in these hardware mutex.

The memory acceleration system 108 can further include a mailbox inter-process communication (IPC) unit 222. The mailbox IPC unit 222 can use a mechanism that allows the host processor 104 and the main processor 202 to communicate with each other. For example, the host processor 104 and the main processor 202 can send messages or trigger interrupts to each other through the mailbox IPC unit 222. In some implementations, the mailbox IPC unit 222 can use doorbell (e.g., just interrupt line) based or message based (e.g., using interrupt and message) IPCs.

FIG. 3 is a message sequence chart illustrating an example process 300 performed by the memory acceleration system 108. While the process 300 is described with reference to the memory acceleration system 108, this description is provided for illustrative purposes only and is not intended to be limiting. In practice, the process 300 can be applied to other instances of processing units or equivalents thereof. It is understood that steps or operations shown in the process 300 are not exhaustive and that other operations can be performed as well before, after, or between any of the illustrated operations. Further, some of the steps or operations may be omitted, performed simultaneously, or performed in a different order than those shown in FIG. 3.

In the example of FIG. 3, the PEs 204 of the memory acceleration system 108 include at least a first PE (also referred to as PE 204a) and a second PE (also referred to as PE 204b). Each of the first PE 204a and the second PE 204b can be configured to receive a respective memory operation task from the main processor 202. The respective memory operation task is associated with corresponding target data.

At 302, the main processor 202 can receive a plurality of memory operation tasks (e.g., from the host processor 104 of FIGS. 1 and 2). In some implementations, the main processor 202 can receive the plurality of memory operation tasks from the host processor through a mailbox inter-process communication (IPC) unit (e.g., as shown in FIG. 2).

In some implementations, the plurality of memory operation tasks includes at least a first memory operation task, a second memory operation task, and a third memory operation task. For example, the plurality of memory operation tasks can be part of a garbage collection process, which refers to automatically identifying and reclaiming memory that is no longer in use by a program. In this example, the memory acceleration system and be referred to as a garbage collector, and each of the first, second, and third memory operation tasks can be a respective memory operation to be performed on one or objects from an object graph. Each object may represent a block of memory that has been allocated to store data (e.g., variables, arrays, or any other data structures) and is accessible through references in the program. The garbage collection process can be configured to traverse the object graph, check each object in the object graph, and mark the object when determining that the object is not being used. It is understood that this example is for illustration purpose only and is not intended to be limiting. In practice, the memory acceleration system 108 can be configured to perform any suitable memory operation tasks.

At 304, the main processor 202 can assign the first memory operation task and the second memory operation task to the PE 204a. For example, the main processor 202 can directly transmit an instruction to perform the first memory operation task and an instruction to perform the second memory operation task to the PE 204a. The instruction to perform the first memory operation task and the instruction to perform the second memory operation task can be transmitted through either the same message or separate messages from the main processor 202 to the PE 204a. In some implementations, the main processor 202 can assign the first memory operation task and the second memory operation task to the PE 204a through the job dispatcher 214 of FIG. 2.

It is understood that in practice, the PE 204a can obtain a memory operation task from other components, such as outside of the memory acceleration system 108 (e.g., the host processor 104), the job dispatcher 214, or the PE 204a itself. Alternatively, in some implementations, the PE 204a can obtain a memory operation task from another PE (e.g., the PE 204b).

At 306, the main processor 202 can assign a third memory operation task to the PE 204b, e.g., by transmitting an instruction to perform the third memory operation task to the PE 204b. In some implementations, the third memory operation task can be assigned to the PE 204b by the job dispatcher 214.

After receiving the first memory operation task and the second memory operation task, the PE 204a can perform these tasks. In some implementations, the PE 204a can have the capability to run multiple threads. For example, at 308, the PE 204a can execute a first thread to process the first memory operation task. The first memory operation task is a memory operation task to be performed on first target data. At 310, the PE 204a can transmit a status request to the remapper 210. The status request can be a request to determine whether the first target data is stored in a data cache (e.g., the data cache 212 of FIG. 2). At 312, the remapper 210 can transmit a status response to the PE 204a. The status response can indicate whether the first target data is stored in the data cache 212.

If the status response indicates that the first target data is stored in the data cache 212, the PE 204a can directly access the first target data from the data cache 212 (not shown in FIG. 3).

In some implementations, the status response indicates that the first target data is not stored in the data cache 212. The PE 204a can determine that the first target data is stored in an external memory (e.g., the memory 106 of FIG. 1 or the DRAM 206 of FIG. 2). At 314, the PE 204a can transmit an instruction to perform a first memory-to-memory operation to the memory offloading engine 208. The first memory-to-memory operation can be generated, for example, based on the first memory operation task. In some implementations, the operations to transmit the status request (at 310), receive the status response (at 312), and transmit the instruction to perform the first memory-to-memory operation (at 314) can be considered as part of the operation 308. In some implementations, the memory offloading engine 208, rather than the PE 204a or the remapper 210, can be configured to check whether the target data is stored in the data cache 212.

At 316, after transmitting the first memory-to-memory operation to the memory offloading engine 208, the PE 204a can pause the first thread.

At 318, the PE 204a can execute a second thread to process the second memory operation task. Similar to the operation 308, the PE 204a can determine whether the target data (e.g., second target data) associated with the second memory operation task is stored in the data cache 212 (e.g., by communicating with the remapper 210, which is not shown in FIG. 3). If the second target data associated with the second memory operation task is not stored in the data cache 212, the PE 204a can transmit an instruction to perform another memory-to-memory operation to the memory offloading engine 208 (not shown in FIG. 3).

At 320, the PE 204a can receive first feedback from the memory offloading engine 208. The first feedback can be a message, which indicates that the first memory-to-memory operation is finished. At 332, after receiving the first feedback, the PE 204a can resume the first thread to continue the first memory operation task.

It is understood that the above example is for illustration purpose and is not intended to be construed in a limiting sense. In practice, a thread of the PE 204a can run more than one memory operation tasks. For example, a memory operation task from the job dispatcher 214 can trigger or become multiple memory access operations. In this case, a thread can request multiple memory accesses before switching to another thread and waiting for the completion of these multiple memory accesses.

It is also understood that the above thread-based multitasking programming model is for illustration purposes and is not intended to be construed in a limiting sense. In some implementations, the PEs 204 can perform multiple memory operation tasks using co-routines. For example, multiple tasks can be executed as co-routines in one thread. The co-routine based programming model allows the memory operation tasks to be handled in a fast and lightweight way (e.g., with minimal memory overhead). Alternatively, in some other implementations, the PEs 204 can perform multiple memory operation tasks using a combination of co-routines and threads. For example, the PEs 204 can run multiple threads, and each thread can execute one or more co-routines.

Similar to the operation performed by the PE 204a, at 324, the PE 204b can also execute a thread to process the third memory operation task. For example, the PE 204b can determine whether the target data (e.g., third target data) associated with the third memory operation task is stored in the data cache 212 (e.g., by communicating with the remapper 210, which is not shown in FIG. 3). At 326, if the third target data is not stored in the data cache 212, the PE 204b can transmit an instruction to perform a second memory-to-memory operation to the memory offloading engine 208. The second memory-to-memory operation can be generated, for example, based on the third memory operation task. At 328, the PE 204b can receive second feedback from the memory offloading engine 208. The second feedback can indicate whether the second memory-to-memory operation is finished or not.

In some implementations, the memory offloading engine 208 can support atomic memory operations, which can refer to a memory operation performed as a single and indivisible step. In other words, the memory offloading engine 208 can be configured to ensure data consistency when the same memory is accessed by multiple threads at the same time. For example, the first memory-to-memory operation (at 314) and the second memory-to-memory operation (at 326) can be atomic memory operations. In addition, these operations can request access to the same memory address. In other words, the first target data and the third target data can be the same. In this case, the memory offloading engine 208 can perform the first memory-to-memory operation with the external memory. After the first memory-to-memory operation is finished, the memory offloading engine 208 can transmit the first feedback (e.g., at 320) and perform the second memory-to-memory operation with the external memory. In this way, the memory offloading engine 208 can ensure that the second memory-to-memory operation does not interrupt (e.g., overriding the first target data) the first memory-to-memory operation.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A memory acceleration system comprising:
a memory offloading engine; and
a plurality of memory acceleration processing elements (PEs), wherein each memory acceleration PE is configured to:
receive a respective memory operation task, wherein the respective memory operation task is associated with corresponding target data; and
communicate with a data cache when the corresponding target data is in the data cache or schedule a memory-to-memory operation with an external memory for the memory offloading engine when the corresponding target data is not in the data cache.

2. The memory acceleration system of claim 1, wherein each memory acceleration PE is configured to execute threads, co-routines, or a combination of threads and co-routines.

3. The memory acceleration system of claim 2, further comprising a remapper coupled to the data cache and configured to:
receive a status request associated with the corresponding target data from each memory acceleration PE; and
transmit a status response to each memory acceleration PE, wherein the status response indicates whether or not the corresponding target data is in the data cache.

4. The memory acceleration system of claim 2, further comprising a job dispatcher configured to manage a plurality of memory operation tasks for the plurality of memory acceleration PEs, wherein:
the plurality of memory acceleration PEs comprises a first memory acceleration PE; and
the plurality of memory operation tasks comprises a first memory operation task and a second memory operation task both assigned to the first memory acceleration PE, wherein the first memory operation task is associated with first target data.

5. The memory acceleration system of claim 4, wherein the first memory acceleration PE is configured to perform:
receiving the first memory operation task and the second memory operation task through the job dispatcher;
executing a first thread to process the first memory operation task;
pausing the first thread; and
executing a second thread to process the second memory operation task.

6. The memory acceleration system of claim 5, wherein executing the first thread to process the first memory operation task comprises:
determining whether the first target data is in the data cache;
when the first target data is not in the data cache, generating an instruction to perform a first memory-to-memory operation based on the first memory operation task; and
transmitting the instruction to perform the first memory-to-memory operation to the memory offloading engine.

7. The memory acceleration system of claim 6, wherein the first memory acceleration PE is configured to:
receive a message from the memory offloading engine, wherein the message indicates that the first memory-to-memory operation is finished; and
resume the first thread to continue a remaining part of the first memory operation task.

8. The memory acceleration system of claim 6, wherein the plurality of memory operation tasks further comprises a third memory operation task that is associated with the first target data and is assigned to a second memory acceleration PE of the plurality of memory acceleration PEs.

9. The memory acceleration system of claim 8, wherein the memory offloading engine is configured to:
receive the instruction to perform the first memory-to-memory operation from the first memory acceleration PE;
receive an instruction to perform a second memory-to-memory operation from the second memory acceleration PE, wherein the second memory-to-memory operation is associated with the first target data and is generated by the second memory acceleration PE based on the third memory operation task, and the first memory-to-memory operation and the second memory-to-memory operation are atomic memory operations; and
perform the first memory-to-memory operation and the second memory-to-memory operation with the external memory asynchronously.

10. The memory acceleration system of claim 4, wherein the memory acceleration system is coupled to a host processor and is configured to receive the plurality of memory operation tasks from the host processor.

11. The memory acceleration system of claim 10, wherein the host processor and the memory acceleration system are configured to share the data cache, the data cache comprises a static random-access memory (SRAM), and the external memory comprises a dynamic random-access memory (DRAM).

12. A computer-implemented method performed by a memory acceleration system comprising
a memory offloading engine; and
a plurality of memory acceleration processing elements (PEs),
the method comprising:
receiving, by each memory acceleration PE, a respective memory operation task, wherein the respective memory operation task is associated with corresponding target data; and
communicating, by each memory acceleration PE, with a data cache when the corresponding target data is in the data cache or scheduling a memory-to-memory operation with an external memory for a memory offloading engine of the memory acceleration system when the corresponding target data is not in the data cache.

13. The method of claim 12, wherein each memory acceleration PE is configured to execute threads, co-routines, or a combination of threads and co-routines.

14. The method of claim 13, wherein the system comprises a remapper coupled to the data cache, and the method further comprising:
receiving, by the remapper, a status request associated with the corresponding target data from each memory acceleration PE; and
transmiting, by the remapper, a status response to each memory acceleration PE, wherein the status response indicates whether or not the corresponding target data is in the data cache.

15. The method of claim 13, wherein the system comprises a job dispatcher configured to manage a plurality of memory operation tasks for the plurality of memory acceleration PEs, wherein:
the plurality of memory acceleration PEs comprises a first memory acceleration PE; and
the plurality of memory operation tasks comprises a first memory operation task and a second memory operation task both assigned to the first memory acceleration PE, wherein the first memory operation task is associated with first target data.

16. The method of claim 15, further comprising performing, by the first memory acceleration PE, operations comprising:
receiving the first memory operation task and the second memory operation task through the job dispatcher;
executing a first thread to process the first memory operation task;
pausing the first thread; and
executing a second thread to process the second memory operation task.

17. The method of claim 16, wherein executing the first thread to process the first memory operation task comprises:
determining whether the first target data is in the data cache;
when the first target data is not in the data cache, generating an instruction to perform a first memory-to-memory operation based on the first memory operation task; and
transmitting the instruction to perform the first memory-to-memory operation to the memory offloading engine.

18. The method of claim 17, further comprising performing, by the first memory acceleration PE, operations comprising:
receiving a message from the memory offloading engine, wherein the message indicates that the first memory-to-memory operation is finished; and
resuming the first thread to continue a remaining part of the first memory operation task.

19. The method of claim 17, wherein the plurality of memory operation tasks further comprises a third memory operation task that is associated with the first target data and is assigned to a second memory acceleration PE of the plurality of memory acceleration PEs.

20. A non-transitory machine-readable storage medium, storing instructions that are executable by a memory acceleration system comprising:
a memory offloading engine; and
a plurality of memory acceleration processing elements (PEs),
wherein the instructions, when executed by the system, cause the system to perform operations comprising:
receiving, by each memory acceleration PE, a respective memory operation task, wherein the respective memory operation task is associated with corresponding target data; and
communicating, by each memory acceleration PE, with a data cache when the corresponding target data is in the data cache or schedule a memory-to-memory operation with an external memory for a memory offloading engine of the processing system when the corresponding target data is not in the data cache.
